(19) United States
(12) Patent Application Publication
(10) Pub. No.: US 2018/0187768 A1
(43) Pub. Date: Jul. 5, 2018

(54) GEAR UNIT FOR A MOTOR VEHICLE

(71) Applicant: Ford Global Technologies, LLC, Dearborn, CA (US)

(72) Inventors: Gerhard Friederich, Bornheim (DE); Alexander Ein Waldt, Köln (DE)

(73) Assignee: Ford Global Technologies, LLC, Dearborn, MI (US)

(21) Appl. No.: 15/859,471

(22) Filed: Dec. 30, 2017

(30) Foreign Application Priority Data
Jan. 2, 2017 (DE) 102017200008.2

(51) Int. Cl. F16H 57/022; F16H 1/16

(52) U.S. Cl. CPC F16H 57/022; F16H 2057/0213; F16H 1/16

(57) ABSTRACT

A gear unit for a motor vehicle including a worm gear shaft mounted on a housing with a drive side rotary bearing and a loose end side rotary bearing. The worm gear shaft pretensioned against a worm gear wheel. A buffer element and a contact face opposite the buffer element configured to limit movement of the end side rotary bearing against the pretension. The buffer element arranged, at least partially, in a buffer receiver. In an exemplary embodiment, the buffer element is precompressed in the buffer receiver.

### CROSS-REFERENCE TO RELATED APPLICATIONS

Not Applicable.

### BACKGROUND OF THE INVENTION

### 1. Field of the Invention

A gear unit for a motor vehicle; and more specifically a gear unit including a worm gear shaft supported on a housing via rotary bearings and pretensioned against a worm gear wheel.

### 2. Description of Related Art

Modern motor vehicles are usually equipped with a power-assisted steering system, which supports the driver's steering movements. In addition, and if necessary, the steering system may generate a particular steering moment to point the driver to a recommended steering movement. Both motorized power steering systems and hydraulic power steering systems are known. A motorized power steering system usually includes an electric servo motor with a drive shaft acting on a worm gear shaft, which in turn cooperates with a worm gear wheel. The worm gear wheel engages a steering shaft, acting via a pinion and rack. Similar systems using a servo motor, worm gear shaft and worm gear wheel are used in other areas of motor vehicles, for example window lifters.

Theoretically, under ideal conditions, optimum engagement between the worm gear shaft and worm gear wheel is possible even with the worm gear shaft rotating around a fixed axis. In practice the engagement deteriorates due to factors such as production-induced or installation-induced inaccuracies, wear effects, soiling and environmental influences such as moisture and temperature. These factors, alone or in combination, may lead to a loose or tight engagement between the worm gear shaft and worm gear wheel. Too tight an engagement is a problem because it leads to increased friction, makes the gears difficult to move, and increases wear.

Such systems may mount the worm gear shaft, on a side facing the drive shaft, with a first roller bearing allows a degree of pivot movement transversely to the axial direction, while at the opposite end the worm gear shaft is mounted via a second roller bearing connected to a gear housing or similar via a spring, loading it in the direction of the worm gear wheel. The worm gear shaft may pivot about the first roller bearing to remain engaged with the worm gear wheel.

The second roller bearing may, under certain circumstances move against the pretension direction and knocks against the housing or toothing of the gear itself, leading to the possibility of clattering noises undesirable from NVH aspects (Noise Vibration Harshness). An elastic buffer element made of rubber or a similar material may be arranged on the housing in to absorb movement of the roller bearing.

### SUMMARY OF THE INVENTION

A gear unit for a motor vehicle including a worm gear shaft mounted on a housing. A buffer element and a buffer element receiver having an open end and sidewalls. The buffer element at least partially in the buffer element receiver and exerting a force on at least one of the sidewalls.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic depiction of a gear unit according to a first embodiment of the present invention.

FIGS. 2A-2D our detailed views of the gear unit from FIG. 1 in various states.

FIG. 2E is a force-travel diagram for the states in FIGS. 2A, 2C and 2D.

FIG. 3 is a diagrammatic depiction of a part of a second embodiment of a gear unit.

FIG. 4 is a diagrammatic depiction of a part of a third embodiment of a gear unit.

FIG. 5 is a diagrammatic depiction of a gear unit according to a fourth embodiment of the present invention.

FIG. 6 is a right side end view of the gear unit of FIG. 5.

FIG. 7 shows a diagrammatic depiction of a fifth embodiment of a gear unit.

### DETAILED DESCRIPTION OF THE PREFERRED EMBODIMENTS

The following description of the preferred embodiment(s) is merely exemplary in nature and is in no way intended to limit the invention, its application, or uses. In the different figures, identical parts are always provided with the same reference signs, and so said parts are generally also described only once.

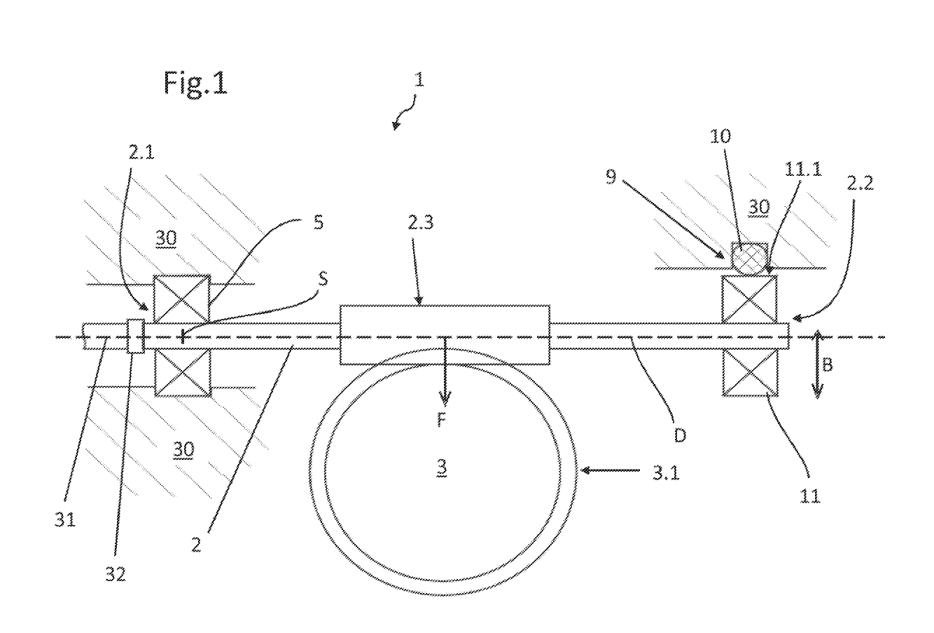

FIG. 1 is a partial cross-section diagrammatic depiction of a first embodiment of a gear unit 1 according to the invention, which may be used for example, in a power steering system of a car. The diagrammatic depiction is partially simplified.

The gear unit 1 has a worm gear shaft 2 mounted rotatably about a rotation axis D, in a housing 30. The gear unit 1 also includes a worm gear wheel 3, rotatably mounted, like the worm gear shaft 2, in the housing 30. The housing 30 usually including several parts, rigidly connected together. A worm screw 2.3 of the worm gear shaft 2 cooperates with a gear ring 3.1 of the worm gear wheel 3. At a first end 2.1, the worm gear shaft 3 connects to a drive shaft 31 of a servo motor (not shown) via a clutch 32, shown diagrammatically.

A drive-side rotary bearing 5 mounts the first end 2.1 of the worm gear shaft 2 on the housing 30. The rotary bearing 5 may, for example be a roller bearing, in particular a ball bearing. While the rotary bearing 5 is a fixed bearing it allows a slight pivotability about a pivot axis S intersecting the rotation axis D and extending perpendicular thereto.

An end side rotary bearing 11 connected to a second end 2.2 of the worm gear shaft 2, lying opposite the first end 2.1, is referred to as a loose bearing. The end side rotary bearing 11 may be a roller bearing; e.g. a ball bearing. The combination of the loose end side rotary bearing 11 and the pivotability in the region of the pivot axis S, the end side rotary bearing 11 allows compensation movements in a movement direction B. The compensation movements compensate for production tolerances of the worm gear shaft 2, worm gear wheel 3, or age-induced wear thereof. Pretensioning the worm gear shaft 2 against the worm gear wheel 3 provides an optimal engagement between the worm gear shaft 2 and the worm gear wheel 3. The pretension creates a pretension force F in the region of the engagement. The corresponding pretension force F may be generated by a suitable pretension element, e.g. a coil spring or other spring, on at least one of the two rotary bearings 5, 11. For reasons of clarity, such a pretension element is not shown here.

In the disclosed example, for NVH reasons, the end side rotary bearing 11 does not impact against or contact the housing 30, as such may lead to undesirable clattering noises. A buffer element 10 is arranged between the rotary bearing 11 and the housing 30 in the movement direction B. The housing 30 includes a buffer receiver 9 in which the buffer element 10 is received. The buffer element 10 cooperates with a contact face 11.1 of the rotary bearing 11 to limit movement of the rotary bearing 11 against the pretension; i.e., away from the worm gear wheel 3. The contact face 11.1 acts on the buffer element 10 and by compression thereof generates a restoring force that counters said movement.

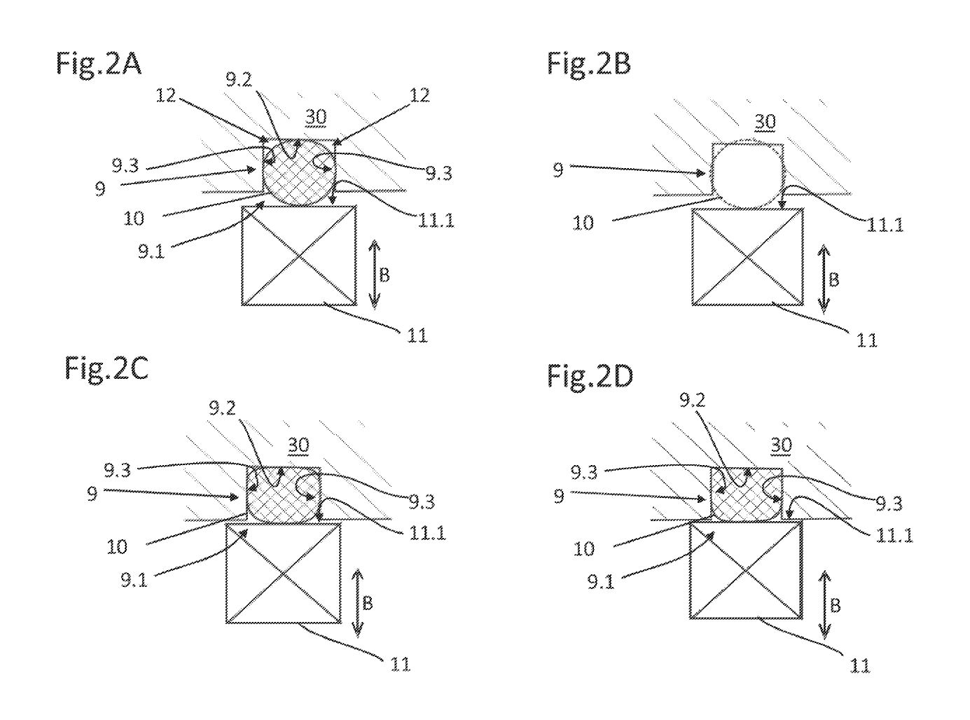

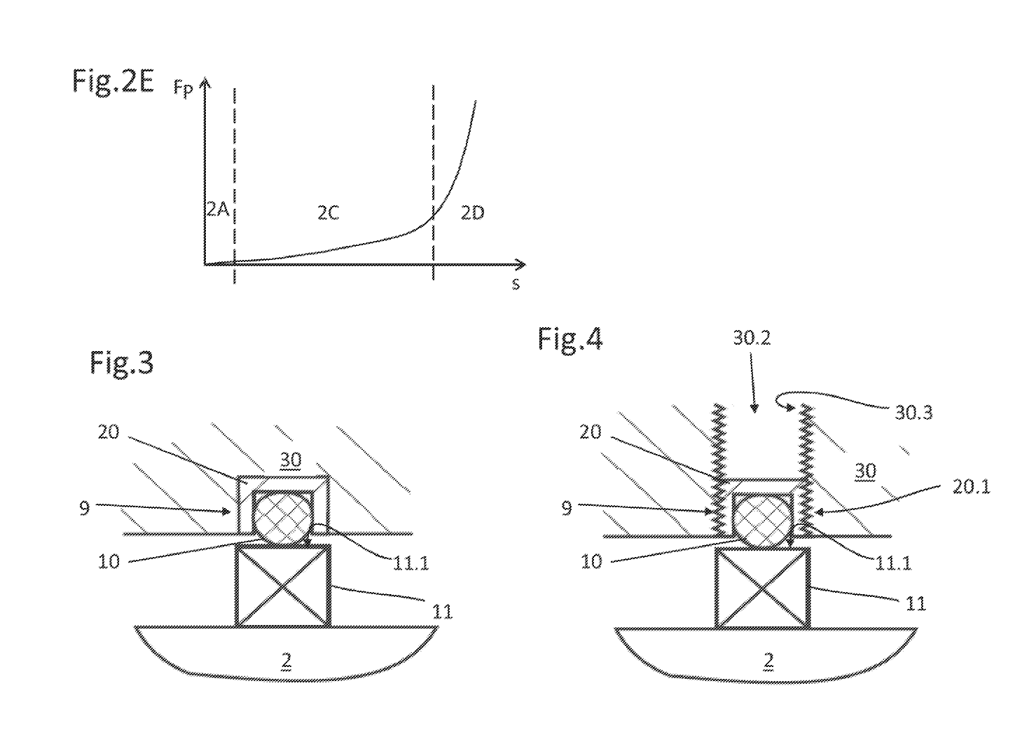

FIG. 2A shows the buffer receiver 9 having an opening 9.1 facing the contact face 11.1 of the rotary bearing 11. The buffer element 10 partially protrudes out of the opening 9.1 and contacts or lies on portions of the inside surface of the buffer receiver 9. As illustrated, the buffer element 10 lies on a base 9.2 opposite the opening 9.1, and on a side walls 9.3 extending between the opening 9.1 and the base 9.2. In the example shown, the interior of the buffer receiver 9 has a square or rectangular cross-section, while the buffer element 10 has a circular cross-section in its relaxed state, see dotted lines in FIG. 2B. This is purely exemplary and other shapes are also possible. In some embodiments, the buffer element 10 may be used alone or additionally to generate the pretension force F. In the disclosed embodiment, the buffer element 10 constantly contacts the contact face 11.1 and is pretensioned between the contact face 11.1 and the buffer receiver 9. In other embodiments, the pretension force F may be generated exclusively by an above-mentioned pretension element, wherein the buffer element 10 may function as a stop damper.

FIG. 2A shows the rotary bearing 11 exerting no force or only a small force on the buffer element 10, wherein a clear space 12 exists between the buffer element 10 and the buffer receiver 9. The space 12 arranged on a side of the buffer element 10 facing away from the contact face 11.1. The buffer element 10 dimensioned so its diameter is slightly larger than the inner diameter of the buffer receiver 9. FIG. 2B shows the outer contour of the buffer element 10 in relaxed state by the dotted line. Because of this dimensioning, the buffer element 10 is precompressed when introduced into the buffer receiver. This leads to a greater restoring force being generated from the outset under the action of the contact face 11.1. However, even without the precompression, due to the buffer receiver 9, which limits the deformation and in particular the lateral expansion of the buffer element 10, a faster rise in the restoring force occur than without the buffer receiver 9. This effect is further amplified by the precompression described. As well as influencing the restoring force, the buffer receiver 9 may also support the buffer element 10, limiting its deformation, and having a positive effect on the service life.

FIG. 2A shows a state in which no force or only a negligible force is applied by the contact face 11.1, shown in the force-travel diagram FIG. 2E, relating to FIGS. 2A, 2C and 2D. FIG. 2E shows the force FP acting between the buffer element 10 and the contact face 11.1 over a deflection s in the movement direction B. The force curve shown in FIG. 2E is purely qualitative and exemplary. Depending on the material and geometry of the buffer element 10, and depending on the geometry of the buffer receiver 9, a different force curve may result. FIG. 2C shows a state of greater force action that may, for example, occur if the buffer element 10 is used, alone or with the spring, as a pretension element. This force action leads to a greater deformation of the buffer element 10 which moves into the space 12. The more the buffer element 10 fills the space 12, the faster the growth in the generated restoring force. As long as the space 12 is substantially clear, the buffer element 10 reacts comparatively “softly”, whereas when it largely or completely fills the space 12, its behavior is “hard”, whereby even very slight position changes of the rotary bearing 11 relative to the housing 30 lead to substantial changes in the restoring force. The restoring action of the buffer element 10 is more moderate over a particular range along the movement direction B, while when the rotary bearing 11 approaches the housing 12, this effect increases disproportionately, effectively suppressing any knocking. FIG. 2D shows a state in which the space 12 is filled, whereby the buffer element 10 becomes almost incompressible. As shown in FIG. 2E, even small movements of the rotary bearing 11 lead to a significant rise in the restoring force.

FIGS. 3 and 4 show a second and a third embodiment of a gear unit 1 substantially corresponding to the embodiment in FIG. 1. As shown, the buffer receiver 9 is formed by sleeve 20 received in the housing 30. In the embodiment shown in FIG. 3, the sleeve 20 is placed in a fixed position in the housing 30, wherein for same housing, different sleeves 20 may be used, sometimes combined with different buffer elements 10. In FIG. 4, the sleeve has an external thread 20.1 which cooperates with an internal thread 30.3 of a bore 30.2 of the housing. In this way, the sleeve 20 is adjustable in the direction towards the contact face 11.1 and away from the contact face 11.1, in the opposite direction). This corresponds to a shift of the rotary bearing 11 in the movement direction B. This embodiment makes him it is possible to adjust the buffer element 10 relative to the contact surface 11.1, which affects the restoration behavior.

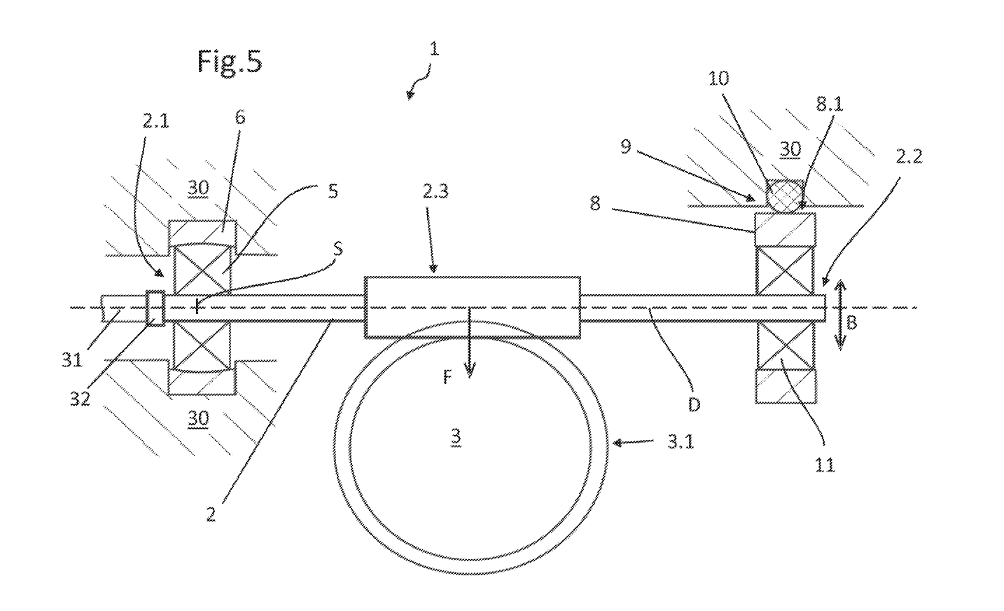

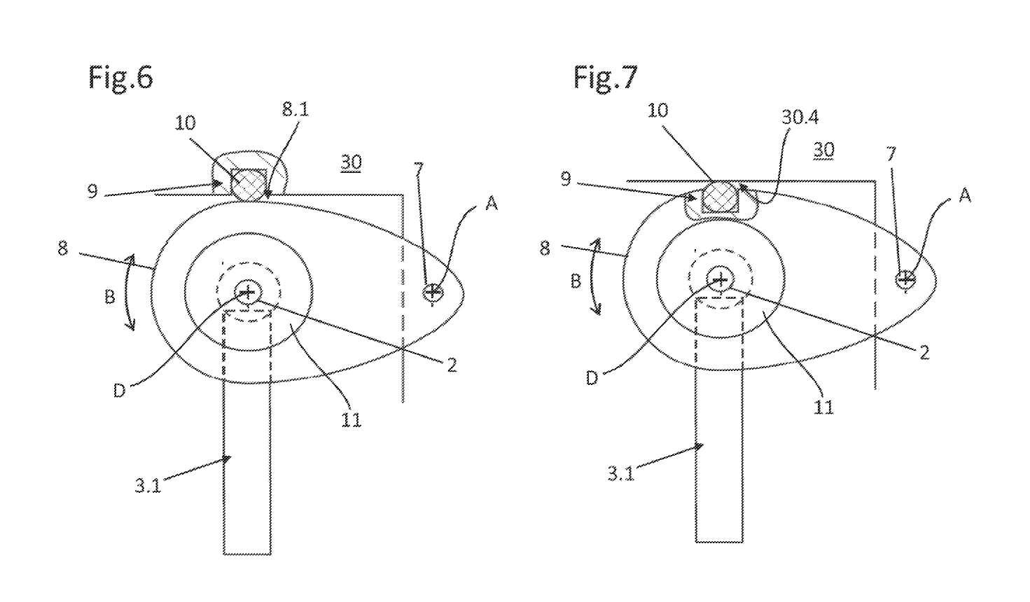

FIGS. 5 and 6 show a fourth embodiment of a gear unit 1 in which the drive-side rotary bearing 5 has a convex outer face guided in a concave inner face of a pivot ring 6. FIG. 6 shows only the region of the rotary bearing 11. The pivot ring 6 being stationary on the housing 30. With this construction, the rotary bearing 5 pivots about the pivot axis S. As shown the end-side rotary bearing 11 is received in a bearing carrier 8 connected to the housing 30 with an axis pin 7 and pivots about a pivot axis A parallel to the rotation axis D. The movement direction B of the end-side rotary bearing 11 corresponds more to an arc than a straight line, which is negligible under the slight deflection movements of the rotary bearing 11. As evident from FIGS. 5 and 6, the embodiment of the buffer receiver 9 and the buffer element 10 does not differ from FIG. 1, although the variants in FIGS. 3 and 4 could be used. The contact face 8.1 formed by the bearing carrier 8 surrounding the rotary bearing 11.

FIG. 7 shows a fifth embodiment of a gear unit 1 resembling the embodiment shown in FIGS. 5 and 6. As shown, the buffer receiver 9 is formed by the bearing carrier 8, while a contact face 30.4 is formed on the housing 30. It is possible that, in the same way as FIGS. 3 and 4, a sleeve 20 is inserted in the bearing carrier 8 and may be adjustable relative thereto.

The disclosed embodiments relate to a gear unit for a motor vehicle, such as private cars and commercial vehicles. The gear unit may be a gear unit for a power steering system, although other applications; e.g., window lifters, electric seat adjustment mechanisms, or similar mechanisms are possible.

The gear unit 1 includes a worm gear shaft 2. The worm gear shaft 2 normally coupled, directly or indirectly, to a drive shaft of a servo motor running approximately coaxially. A clutch or clutch arrangement transmits a torque from the driveshaft to the worm gear shaft 2. In the operating state, the worm gear shaft 2 cooperates with a worm gear wheel 3 normally regarded as part of the gear unit. The gear unit stepping down the rotary motion of the drive shaft.

The worm gear shaft 2 mounted on a housing 30 via a drive side rotary bearing 5 and an end side rotary bearing 11. The worm gear shaft 2 is pretensioned against the worm gear wheel 3. The housing 30 forms a reference frame normally stationary relative to the vehicle, against which the relative positions of the movable gear components are at least partially defined. The housing may be made of one piece or be multipiece. It may be configured open to a varying extent, in which case it could also be described as a “frame” or similar. It is also possible that the gear components mentioned here, where applicable together with further gear components, are largely surrounded by the housing. The worm gear shaft 2 rotates relative to the housing about a rotation axis D extending between the drive side rotary bearing 5 and the end side rotary bearing 11. The two rotary bearings 5, 11 are normally roller bearings, in particular ball bearings. However, the rotary bearing may also be configured as a plain bearing.

Normally, the drive side rotary bearing 5 is on one side of the worm gear wheel 3, and the end side rotary bearing 11 is on the other side of the worm gear wheel 3. The worm gear wheel 3 or a region of the worm gear shaft 2 engaging the worm gear wheel 3 is arranged between the rotary bearings 5, 11. The drive side rotary bearing 5 is arranged on the side on which the force is applied by a drive, e.g. a servo motor. The end side rotary bearing 11 arranged towards the end of the worm gear shaft 2. The end side rotary bearing 11 is a loose rotary bearing; i.e., a loose bearing provided in a known fashion to allow a movement of the worm gear shaft 2 relative to the worm gear wheel 3 and compensating for production inaccuracies and age-induced wear on the worm gear shaft and/or worm gear wheel. To allow reliable engagement between the worm gear shaft 2 and worm gear wheel 3, the worm gear shaft is mounted by the rotary bearings 5, 11 such that it is pretensioned against the worm gear wheel 3. This may be achieved via a suitable elastic pretension element, a metal spring or similar element, arranged between the housing and the respective rotary bearing. The pretension of the rotary bearing defines a pretension of the worm gear shaft 2 in the direction towards the worm gear wheel 3. The corresponding pretension acts to ensure that the worm gear shaft 2 remains in engagement with the worm gear wheel 3, wherein a corresponding pretension element, because of its elastic property, may simultaneously allow deflection of the worm gear shaft 2, whereby friction forces between the worm gear shaft 2 and the worm gear wheel 3 may be limited.

To allow the movement of the loose end side rotary bearing 11 relative to the housing 30, pivotability of the worm gear shaft in the region of the drive side rotary bearing 5 is provided. In one embodiment, the drive side rotary bearing 5 is configured to be pivotable, and the end side rotary bearing 11 is pretensioned toward the worm gear wheel 3. For example, an outer bearing ring of a roller bearing forming the drive side rotary bearing may be received inside a pivot ring on the housing side. Whereas the drive side rotary bearing is pivotable, about a pivot axis running perpendicular to the rotation axis of the worm gear shaft, and the end side rotary bearing 11 is movable relative to the housing corresponding to the pivot movement, wherein the pretension element acts directly or indirectly on the rotary bearing. In another embodiment, the drive side rotary bearing is pretensioned toward the worm gear wheel.

In one exemplary embodiment, gear unit has a rubber-elastic buffer element 10, and an opposing contact face designed to limit movement of the end side rotary bearing 11 against the pretension. The rubber-elastic buffer element 9 may be made of rubber or another suitable elastomer, e.g. silicone. It cooperates with the opposite contact face to limit movement of the end side rotary bearing 11, meaning a degree of movement remains possible.

Movement of the end side rotary bearing 11 away from the worm gear wheel 3 is limited, movement against the pretension is limited; i.e., that is against the action of the pretension force toward the worm gear wheel. The contact face acts, at least sometimes, on the buffer element 10, whereby it deforms elastically and creates a restoring force limiting movement. If a proposed movement direction is assigned to the end side rotary bearing, the buffer element 10 and the contact face 8.1, 11.1, and 30.4 lie opposite each other in the movement direction. As explained, either the buffer element 10 is assigned to the rotary bearing, connected thereto at least indirectly, and the contact face is assigned to the housing, or vice versa. Normally, the contact face and the buffer element are arranged on a side of the worm gear shaft 2 facing away from the worm gear wheel 3. The contact face 8.1, 11.1, and 30.4 need not be formed flat or cohesive, although both are possible. This is the face that cooperates with the buffer element 10 and acts thereon. In an operating state, the contact face 8.1, 11.1, and 30.4 may lie on the buffer element 10 for some of the time or also permanently. In the latter case, the buffer element and contact face may also cooperate to create at least part of the pretension. Wherein, the buffer element is pretensioned against the contact face.

In one example, the buffer element 10 is arranged at least mainly in a buffer receiver 9 open towards the contact face and lying on the inside. The buffer receiver 9 may comprise a recess, depression, groove, channel, blind bore or similar structure in which the buffer element is at least partially arranged. The buffer receiver 9 is preferably formed non-elastic, it has an elasticity negligible in comparison with that of the buffer element 10. The buffer receiver 9 may be made of plastic or metal or other suitable materials. The buffer element 10 lies on the buffer receiver 9 on the inside, wherein it may lie on the buffer receiver at least in portions, or in some cases over the whole surface. The buffer receiver 9 may partially encloses the buffer element 10, or a partial form-fit exists between the buffer receiver 9 and the buffer element 10. The buffer receiver 9 is opened to the contact face 8.1, 11.1, and 30.4 so contact is possible between the contact face 8.1, 11.1, and 30.4 and the buffer element 10. The buffer element may protrude partially out of the buffer receiver 9, but it may also be received completely in the buffer receiver 9. The contact face 8.1, 11.1, 30.4 may be configured so it moves partially into the buffer receiver 9 to cooperate with the buffer element 10. In relation to an opening of the buffer receiver 9 facing the contact face 8.1, 11.1, and 30.4, the buffer element 10 preferably lies on a base 9.2 of the buffer receiver 9 opposite the opening 9.1, and on at least one side wall 9.3 of the buffer receiver 9 extending between the opening 9.1 and the base 9.2. The form or cross section of the buffer receiver 9, may vary widely, for example it may have a cylindrical, conical, frustoconical or also rounded concave interior. Elongate forms are also conceivable, similar to a groove or channel. The buffer element 10 may have widely varying forms, although its shape and dimension are to a certain extent predefined or predetermined by the buffer receiver 9 since it is received therein. However, the buffer element 10 may also be dimensioned larger and be introduced into the buffer receiver 9 under compression.

Because the buffer element 10 is received in the buffer receiver 9 and lies against the buffer receiver 9 or at least in portions thereof, elastic deformation of the buffer element generates restoring forces between the buffer element 10 and the buffer receiver. In particular, the buffer element 10 is prevented from being able to expand unhindered. In a known fashion, under force application in one direction, a rubber-elastic element tends to expand, or flow, transversely to this direction. The rise in a restoring force is limited by this deflection movement of the rubber-elastic element. If, the expansion is limited or prevented by a form fit with another, non-elastic, element, the restoring force rise quickly. The combination of buffer element 10 and buffer receiver 9 according to the exemplary embodiments allows the generation of strong and in particular rapidly rising restoring forces, a force progression. A slight movement of the end side rotary bearing 11 that leads to a slight deformation of the buffer element 10 results in a low restoring force, whereby the rotary bearing 11 and the worm gear shaft 2 are only lightly loaded. A greater movement results in the restoring force rising faster, reducing knocking on the housing. Also, because the buffer element 10 is recessed into the buffer receiver 9, absolute deformation of the buffer element 10 is limited, which may have an advantageous effect on its service life. It is however also possible that the buffer element 10 is pretensioned against the contact face 8.1, 11.1, and 30.4, whereby a force progression can be achieved even on smaller movements. Normally, only a limited deflection of the shaft occurs, maximizing a toothing overlap in operation and leading to an extended service life of the gear unit.

In the disclosed example, the buffer element 10 may be arranged precompressed in the buffer receiver 9. The term “precompressed” refers to a state without action of the contact face. An outer dimension of the buffer element 10 in the relaxed state is greater than the corresponding inner dimension of the buffer receiver 9, so the buffer element 10 can only be introduced into the buffer receiver 9 and received therein by deformation; i.e., compression. The buffer element 10 is introduced into the buffer receiver 9 under compression. Such compression serves to better secure the position of the buffer element 10 in the buffer receiver 9, since the friction forces acting between these are amplified. The restoring force provided by the buffer element 10, or its rise, can be amplified. At least some of the forces occurring from the precompression can act between the above-mentioned side walls of the buffer receiver 9 and the buffer element 10. Precompression generates forces which act transversely to the movement direction of the end side rotary bearing 11.

As illustrated, at least one space 12 is provided between the buffer element 10 and the buffer receiver 9, into which space 12 the buffer element 10 can move under the action of the contact face 8.1, 11.1, and 30.4. In the region of this space 12, the buffer element 10 does not lie on the buffer receiver 9, absent action with the contact face 8.1, 11.1, and 30.4, that is a gap exists between the elements. Under the action of the contact face 8.1, 11.1, and 30.4, the buffer element 10 deforms, and moves at least partially into the at least one space 12. As long as this is possible, the restoring force rises comparatively slowly. However, as soon as the buffer element 10 fills the space 12 and lies against the buffer receiver 9, further deformation results in a substantial rise or progression of the restoring force. Suitable configuration and arrangement of the space 12 controls the growth or rise in the restoring force. The buffer element 10 reacts more “softly” up to a certain degree of deformation, after exceeding this degree of deformation, for example filling of the space 12, the restoring force becomes “harder”. The space 12 may be arranged on a side of the buffer element 10 facing away from the contact face 8.1, 11.1, and 30.4.

In a further example, the buffer element 10 may lie against the buffer element 9 without a space, at least on a side facing away from the contact face 8.1, 11.1, and 30.4. This may be combined in some cases with the above-mentioned precompression of the buffer element. In any case, the buffer element then acts as relatively “hard” or incompressible from the outset, since it has no space into which it can move.

Movability of the end side rotary bearing 11 may be implemented in various ways. According to one embodiment, the end side rotary bearing 11 is arranged on a bearing carrier 8 movable relative to the housing. Here, the rotary bearing may be connected rigidly to or be received in the bearing carrier 8, so the movability of the rotary bearing relative to the housing results exclusively from the movability of the bearing carrier 8.

The bearing carrier 8 may be pivotable relative to the housing 30 about a pivot axis A running parallel to the rotation axis D of the worm gear shaft 2. The end side rotary bearing 11 arranged at a distance from the pivot axis A and moving along a circular track, the center point of which is the pivot axis A. Insofar as the movements of the end side rotary bearing, and the worm gear shaft received therein, are normally very small, the difference between a circular and a straight movement is usually negligible.

If the buffer element 10 is associated with the end side rotary bearing 11, the buffer receiver 9 may be fixedly connected to the rotary bearing. An embodiment is conceivable in which an outer bearing ring of a roller bearing forms the buffer receiver 9. Here a corresponding receiver would be provided on the outside of the bearing ring to receive the buffer element 10. The buffer receiver 9 may also be connected to the rotary bearing as a separately produced part.

With a movable bearing carrier 8, the buffer receiver 9 may be formed on the bearing carrier 8. It may be formed physically by the same component receiving the rotary bearing. These may be separate components fixedly connected together. A larger carrier part may receive the rotary bearing, wherein a smaller carrier part forming the buffer receiver is connected to or put in the larger carrier part.

In an alternative embodiment, the buffer receiver 9 is formed on the housing 30 or be formed by the housing itself, as the housing is configured rigidly and non-elastically because of its function. It is also conceivable that the buffer receiver 9 is formed by a separately produced component fixedly connected to the housing.

If the buffer receiver 9 is a separate component, it may be configured as a sleeve 20. The buffer receiver 9 may be formed by a sleeve 20 that is adjustable relative to the housing 30 or to the bearing carrier 8 in a direction towards the contact face 8.1, 11.1, and 30.4. The term “sleeve” should be interpreted broadly and designates substantially any shape receiving the buffer element 10. Adjustability may be achieved by providing a sleeve 20 with an external thread 20.1 that engages an internal thread 30.3 of the housing 30. The sleeve 20 can be shifted towards the contact face 8.1, 11.1, and 30.4, whereby the distance between the buffer element 10 received in the sleeve 20 and the contact face 8.1, 11.1, and 30.4 is shortened or reduced in relation to a specific position of the end side rotary bearing 11.

Where the buffer receiver 9 is formed on the housing 30, the contact face 11.1 may be formed on the end side rotary bearing 11. Here, for example, an outer bearing ring of a roller bearing may form the contact face. Optionally, it is possible that the bearing ring is flattened in this region to ensure a better pressure distribution on the buffer element 10. The contact face may be formed on the bearing carrier 8 where present, again the surface of the bearing carrier may be flattened in the corresponding region.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gear unit for a motor vehicle having a worm gear shaft mounted on a housing via a drive side rotary bearing and via a loose end side rotary bearing and pretensioned against a worm gear wheel, an elastic buffer element, and a contact face opposite the elastic buffer element and engaging the elastic buffer element comprising:
a buffer element receiver having an opening, said opening opposite said contact face, the buffer element located at least partially in the buffer element receiver and engaging a side thereof such that the buffer element is precompressed in the buffer receiver.

2. The gear unit of claim 1 including a space between the buffer element and the buffer receiver into which space the buffer element can move under the action of the contact face.

3. The gear unit of claim 1 wherein the loose end side rotary bearing is arranged on a bearing carrier movable relative to the housing.

4. The gear unit of claim 3 wherein the bearing carrier pivots relative to the housing about a pivot axis extending parallel to a rotation axis of the worm gear shaft.

5. The gear unit of claim 3 wherein the buffer receiver is formed on the bearing carrier.

6. The gear unit of claim 3 wherein the buffer receiver is formed on the housing.

7. The gear unit of claim 5 wherein the buffer receiver includes a sleeve adjustable relative to the bearing carrier in a direction towards the contact face.

8. The gear unit of claim 6 wherein the housing includes a sleeve adjustable relative to the housing in a direction towards the contact face.

9. The gear unit of claim 6 wherein the contact face is located on the end side rotary bearing.

10. The gear unit of claim 7 wherein the contact face is formed on the rotary bearing carrier.

11. A gear unit for a motor vehicle comprising:
a worm gear shaft mounted on a housing;
a buffer element;
a buffer element receiver having an open end and sidewalls, said the buffer element located at least partially in the buffer element receiver and exerting a force on at least one of said sidewalls.

12. The gear unit of claim 11 wherein said buffer element includes a relaxed state and a compressed state, said buffer element and said compressed state when located at least partially in said buffer element receiver.

13. The gear unit of claim 11 including a contact face opposite the elastic buffer element and engaging the elastic buffer element.

15. The gear unit of claim 11 including a space between the buffer element and the buffer receiver.

16. A gear unit for a motor vehicle comprising:
a worm gear shaft mounted on a housing with rotary bearing;
a buffer element;
a buffer element receiver having an open end and sidewalls, said the buffer element located at least partially in the buffer element receiver and exerting a force on at least one of said sidewalls; and
said rotary bearing supported on a bearing carrier movable relative to said housing.
